(19) United States
(12) Patent Application Publication
(10) Pub. No.: US 2002/0194263 A1
(43) Pub. Date: Dec. 19, 2002

(54) Hierarchical constraint resolution for application properties, configuration, and behavior

(76) Inventors: Brian T. Murren, Clifton Park, NY (US); Thomas R. Kiehl, Wynantskill, NY (US)

Correspondence Address: LEE & HAYES PLLC, SUITE 500, 421 W RIVERSIDE, SPOKANE, WA, 99201

(21) Appl. No.: 09/845,780

(22) Filed: Apr. 30, 2001

(51) Int. Cl. G06F 15/16

(52) U.S. Cl. 709/203

(57) ABSTRACT

A software architecture permits efficient construction of server software applications for many diverse domains. The architecture implements and enforces constraints that customize the behavior of the application. The constraints can be imposed by a variety of sources (e.g., legal, operating company, customers, end users, cultural customs, etc.). A constraint resolver resolves the constraints at run time, or prior to run time, so that the application behaves and appears appropriately for the given set of constraints.

### TECHNICAL FIELD

The present invention is directed to techniques for constraining how software applications operate, and more particularly, to systems and methods for resolving hierarchical constraints placed on application properties, configuration, and behavior.

### BACKGROUND

Computer software applications are traditionally developed by writing source code for components of the application, including a main module and various other modules, as well as functions or subroutines that are invoked by the modules. The source code is typically developed specifically for the domain of one computer application. Domains pertain to a particular category or area of service that the application provides. Example domains include asset management, leasing and lending, insurance, financial management, inventory tracking, resale and repair management, and so forth. Since the source code is developed specifically for each domain, the components of one computer application developed specifically for one domain might not be reusable for another computer application under development for another domain. Although some utility components (e.g., sort routines) can be reused by different computer applications, they are typically very low-level components that are not related to the domain of the computer application. Because of the inability to reuse high-level components for multiple computer applications across diverse domains, the cost of developing a computer application can be quite high. In addition, because the components are new, their reliability is often unproven.

Many techniques have been developed to facilitate the reusability and reliability of software components. One well-known technique is object-oriented programming. Object-oriented programming allows a programmer to define a type of component, known as an “object”. Each type of object has a defined interface with a defined behavior. A programmer can develop a computer application to use the interfaces of objects that have been developed by other programmers to provide that behavior within the computer application. The behavior of an object is provided by methods (or member functions), and the data of an object is provided as attributes (or data members). Although object-oriented programming techniques have helped increase the reusability and reliability software components, it is still very expensive to develop a computer application even using these reusable components. Part of the expense is attributable to the need of a computer programmer to know and understand all the interfaces of the components in order to integrate the components into the desired computer application.

These problems in developing computer applications are exacerbated by the increase in size and functionality of many modem large-scale server applications. Applications that once could be executed only by very expensive mainframe or supercomputers can now be executed by relatively inexpensive desktop or server computers (or groups thereof). Large-scale applications that are distributed across multiple server computers and support a large amount of functionality are becoming increasingly common. However, due to their size and complexity, these applications typically require large teams of software designers to design, build, and test the applications.

The complexity and large-scale nature of such applications also makes subsequent modifications to the applications difficult. For example, modifying a user interface to support a new computing platform or display language can be very time-consuming, as all user interface aspects of the application are sought out, modified, and tested by the system designers to accommodate the new features. Conversely, any modifications to the underlying problem-solving model implemented in the application can affect the manner in which information is displayed to the user. Such modifications add significant time to the application development as the system designers review and test the problem-solving model to ensure that the new (or remaining) features are operational with the user interface.

Another issue facing developers of large-scale applications is that many different user groups often wish to customize operation of the applications according to their needs and preferences. This customization may affect the applications' properties, configuration, and behavior. For instance, consider an application that can be accessed worldwide by many different users. End users may express certain preferences for how content is displayed. Customs in the user's locale may impose certain preferences. The operating company may wish to impose its own constraints, such as mandating inclusion of branding information or color schemes.

Accordingly, there is a need for new programming techniques that allow for creation of large and complex software applications, while allowing such applications to be customized by resolving diverse constraints imposed from many different sources.

### SUMMARY

A multi-layer software architecture permits efficient and timely construction of business processes and server-based software applications for many diverse domains, such as business-oriented domains like asset management, leasing and lending, inventory tracking, and so forth. The architecture is arranged into several hierarchical layers. An execution environment layer handles incoming requests from remote clients and selects the appropriate problem-solving logic to process the requests. The problem-solving logic is organized within a problem-solving logic layer that defines the application for a specific problem domain. For individual requests, the logic performs various series of tasks to process the requests and produce replies that will be returned to the clients.

A data abstraction layer facilitates retrieval of data from external resources and maps the data into a domain framework for the problem domain. A data coordination layer provides an interface for the logic layer to access the domain framework so that the logic layer can obtain the data from the resources when processing the requests. A presentation layer structures the replies generated by the logic into a desired appearance and encodes the replies using formats and communication protocols supported by different clients (e.g., Web browsers, wireless communications devices, personal digital assistants, etc.).

The application architecture implements and enforces constraints that customize the behavior of the application. The constraints can be imposed by a variety of sources (e.g., legal, operating company, customers, end users, cultural customs, etc.), with each source carrying a different priority. A constraint hierarchy is composed of multiple constraint layers, with each constraint layer establishing a set of constraints that are placed on various configuration parameters and application functions of the application. A constraint resolver resolves the constraints at run time, or prior to run time, so that the application behaves and appears appropriately for the given set of constraints.

### BRIEF DESCRIPTION OF THE DRAWINGS

FIG. 1 illustrates a network system that implements a server application architecture that may be tailored to various domains.

FIG. 2 is a block diagram of the application architecture.

FIG. 3 is a flow diagram illustrating a general operation of the application architecture when handling client requests.

FIG. 4 is a block diagram of an exemplary execution model configured as an asset catalog program and a controller to execute various interactions of the asset catalog program.

FIG. 5 is a flow diagram of a process for executing the asset catalog program.

FIG. 6 is a block diagram of the program controller used in the execution model of FIG. 4.

FIG. 7 is a block diagram of a presentation layer from the application architecture of FIG. 2.

FIG. 8 is a flow diagram of a process for presenting a reply to a client device.

FIG. 9 illustrates a constraint hierarchy that can be configured to implement and enforce constraints to customize behavior of the application.

FIG. 10 is a flow diagram of a process for conforming application operation to the constraints imposed by the constraint hierarchy of FIG. 9.

The same reference numbers are used throughout the figures to reference like components and features.

### DETAILED DESCRIPTION

A software architecture specifies distinct layers or modules that interact with each other according to a well-defined specification to facilitate efficient and timely construction of business processes and server applications for many diverse domains. Examples of possible domains include asset management, leasing and lending, insurance, financial management, asset repair, inventory tracking, other business-oriented domains, and so forth. The architecture implements a common infrastructure and problem-solving logic model using a domain framework. By partitioning the software into a hierarchy of layers, individual modules may be readily “swapped out” and replaced by other modules that effectively adapt the architecture to different domains.

With this architecture, developers are able to create different software applications very rapidly by leveraging the common infrastructure. New business models can be addressed, for example, by creating new domain frameworks that “plug” into the architecture. This allows developers to modify only a portion of the architecture to construct new applications, resulting in a fraction of the effort that would be needed to build entirely new applications if all elements of the application were to be constructed.

Exemplary System

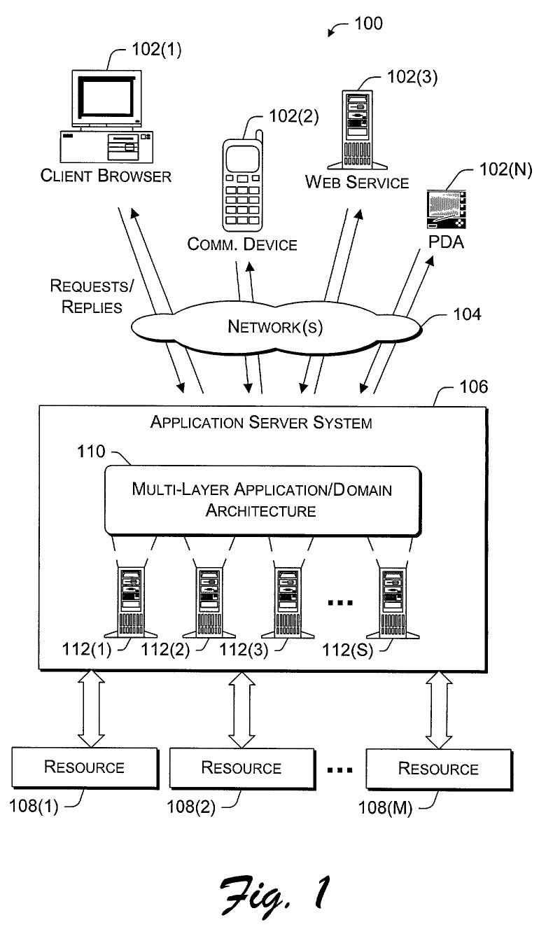

FIG. 1 shows a network system 100 in which the tiered software architecture may be implemented. The system 100 includes multiple clients 102(1), 102(2), 102(3), . . . , 102(N) that submit requests via one or more networks 104 to an application server system 106. Upon receiving the requests, the server system 106 processes the requests and returns replies to the clients 102 over the network(s) 104. In some situations, the server system 106 may access one or more resources 108(1), 108(2), . . . , 108(M) to assist in preparing the replies.

The clients 102 may be implemented in a number of ways, including as personal computers (e.g., desktop, laptop, palmtop, etc.), communications devices, personal digital assistants (PDAs), entertainment devices (e.g., Web-enabled televisions, gaming consoles, etc.), other servers, and so forth. The clients 102 submit their requests using a number of different formats and protocols, depending upon the type of client and the network 104 interfacing a client and the server 106.

The network 104 may be implemented by one or more different types of networks (e.g., Internet, local area network, wide area network, telephone, etc.), including wire-based technologies (e.g., telephone line, cable, etc.) and/or wireless technologies (e.g., RF, cellular, microwave, IR, wireless personal area network, etc.). The network 104 can be configured to support any number of different protocols, including HTTP (HyperText Transport Protocol), TCP/IP (Transmission Control Protocol/Internet Protocol), WAP (Wireless Application Protocol), and so on.

The server system 106 implements a multi-layer software architecture 110 that is tailored to various problem domains, such as asset management domains, financial domains, asset lending domains, insurance domains, and so forth. The multi-layer architecture 110 resides and executes on one or more computers, as represented by server computers 112(1), 112(2), 112(3), 112(S). The tiered architecture 110 may be adapted to handle many different types of client devices 102, as well as new types as they become available. Additionally, the architecture 110 may be readily configured to accommodate new or different resources 108.

The server computers 112 are configured as general computing devices having processing units, one or more types of memory (e.g., RAM, ROM, disk, RAID storage, etc.), input and output devices, and a busing architecture to interconnect the components. As one possible implementation, the servers 112 may be interconnected via other internal networks to form clusters or a server farm, wherein different sets of servers support different layers or modules of the architecture 110. The servers may or may not reside within a similar location, with the software being distributed across the various machines. Various layers of the architecture 110 may be executed on one or more servers. As an alternative implementation, the architecture 110 may be implemented on single computer, such as a mainframe computer or a powerful server computer, rather than the multiple servers as illustrated.

The resources 108 are representative of any number of different types of resources. Examples of resources include databases, websites, legacy financial systems, electronic trading networks, auction sites, and so forth. The resources 108 may reside with the server system 106, or be located remotely. Access to the resources may be supported by any number of different technologies, networks, protocols, and the like.

General Architecture

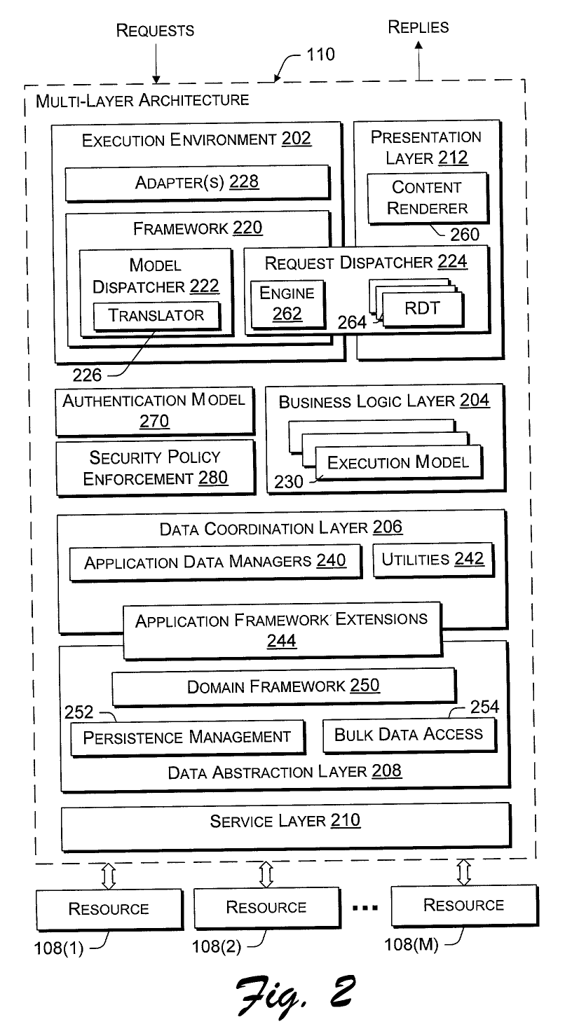

FIG. 2 illustrates one exemplary implementation of the multi-layer architecture 110 that is configured as a server application for a business-oriented domain. The architecture is logically partitioned into multiple layers to promote flexibility in adapting the architecture to different problem domains. Generally, the architecture 110 includes an execution environment layer 202, a business logic layer 204, a data coordination layer 206, a data abstraction layer 208, a service layer 210, and a presentation layer 212. The layers are illustrated vertically to convey an understanding as to how requests are received and handled by the various layers.

Client requests are received at the execution environment 202 and passed to the business logic layer 204 for processing according to the specific business application. As the business logic layer 204 desires information to fulfill the requests, the data coordination layer 206, data abstraction layer 208, and service layer 210 facilitate extraction of the information from the external resources 108. When a reply is completed, it is passed to the execution environment 202 and presentation layer 212 for serving back to the requesting client.

The architecture 110 can be readily modified to (1) implement different applications for different domains by plugging in the appropriate business logic in the business logic layer 204, (2) support different client devices' by configuring suitable modules in the execution environment 202 and presentation layer 212, and (3) extract information from diverse resources by inserting the appropriate modules in the data abstraction layer 208 and service layer 210. The partitioned nature of the architecture allows these modifications to be made independently of one another. As a result, the architecture 110 can be adapted to many different domains by interchanging one or more modules in selected layers without having to reconstruct entire application solutions for those different domains.

The execution environment 202 contains an execution infrastructure to handle requests from clients. In one sense, the execution environment acts as a container into which the business logic layer 204 may be inserted. The execution environment 202 provides the interfacing between the client devices and the business logic layer 204 so that the business logic layer 204 need not understand how to communicate directly with the client devices.

The execution environment 202 includes a framework 220 that receives the client requests and routes the requests to the appropriate business logic for processing. After the business logic generates replies, the framework 220 interacts with the presentation layer 212 to prepare the replies for return to the clients in a format and protocol suitable for presentation on the clients.

The framework 220 is composed of a model dispatcher 222 and a request dispatcher 224. The model dispatcher 222 routes client requests to the appropriate business logic in the business logic layer 204. It may include a translator 226 to translate the requests into an appropriate form to be processed by the business logic. For instance, the translator 226 may extract data or other information from the requests and pass in this raw data to the business logic layer 204 for processing. The request dispatcher 224 formulates the replies in a way that can be sent and presented at the client. Notice that the request dispatcher is illustrated as bridging the execution environment 202 and the presentation layer 212 to convey the understanding that, in the described implementation, the execution environment and the presentation layer share in the tasks of structuring replies for return and presentation at the clients.

One or more adapters 228 may be included in the execution environment layer 202 to interface the framework 220 with various client types. As an example, one adapter may be provided to receive requests from a communications device using WAP, while another adapter may be configured to receive requests from a client browser using HTTP, while a third adapter is configured to receive requests from a messaging service using a messaging protocol.

The business logic layer 204 contains the business logic of an application that processes client requests. Generally speaking, the business logic layer contains problem-solving logic that produces solutions for a particular problem domain. In this example, the problem domain is a commerce-oriented problem domain (e.g., asset lending, asset management, insurance, etc.), although the architecture 110 can be implemented in non-business contexts. The logic in the logic layer is therefore application-specific and hence, is written on a per-application basis for a given domain.

In the illustrated implementation, the business logic in the business logic layer 204 is constructed as one or more execution models 230 that define how computer programs process the client requests received by the application. The execution models 230 may be constructed in a variety of ways. One exemplary execution model employs an interaction-based definition in which computer programs are individually defined by a series of one or more interaction definitions based on a request-response model. Each interaction definition includes one or more command definitions and view definitions. A command definition defines a command whose functionality may be represented by an object that has various attributes and that provides the behavior for that command. A view definition defines a view that provides a response to a request.

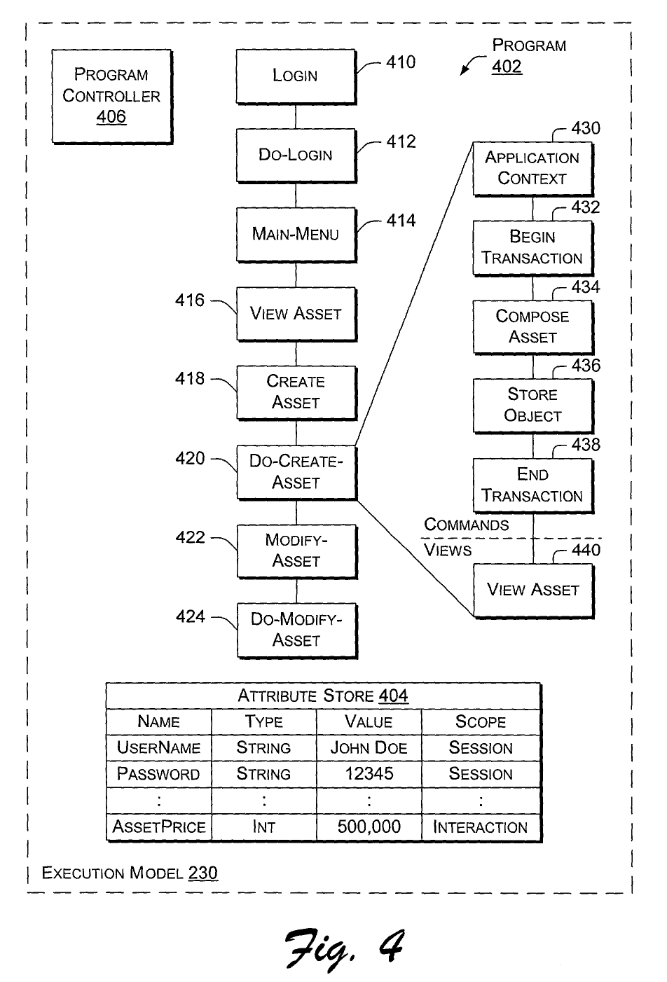

One example of an interaction-based model is a command bean model that employs multiple discrete program modules, called “Command Beans”, that are called for and executed. The command bean model is based on the “Java Bean” from Sun Microsystems, which utilizes discrete Java™ program modules. One particular execution model 230 that implements an exemplary program is described below beneath the heading “Business Logic Layer” with reference to FIGS. 4-6.

Other examples of an execution model include an action-view model and a use case model. The action-view model employs action handlers that execute code and provide a rendering to be served back to the client. The use case model maps requests to predefined UML (Unified Modeling Language) cases for processing.

The data coordination layer 206 provides an interface for the business logic layer 204 to communicate with a specific domain framework 250 implemented in the data abstraction layer 208 for a specific problem domain. In one implementation, the framework 250 utilizes a domain object model to model information flow for the problem domain. The data coordination layer 206 effectively partitions the business logic layer 204 from detailed knowledge of the domain object model as well as any understanding regarding how to obtain data from the external resources.

The data coordination layer 206 includes a set of one or more application data managers 240, utilities 242, and framework extensions 244. The application data managers 240 interface the particular domain object model in the data abstraction layer 208 into a particular application solution space of the business logic layer 204. Due to the partitioning, the execution models 230 in the business logic layer 204 are able to make calls to the application data managers 240 for specific information, without having any knowledge of the underlying domain or resources. The application data managers 240 obtain the information from the data abstraction layer 208 and return it to the execution models 230. The utilities 242 are a group of reusable, generic, and low-level code modules that developers may utilize to implement the interfaces or provide rudimentary tools for the application data managers 240.

The data abstraction layer 208 maps the domain object model to the various external resources 108. The data abstraction layer 208 contains the domain framework 250 for mapping the business logic to a specific problem domain, thereby partitioning the business applications and application managers from the underlying domain. In this manner, the domain framework 250 imposes no application-specific semantics, since it is abstracted from, the application model. The domain framework 250 also does not dictate any functionality of services, as it can load any type of functionality (e.g., JavaT™ classes, databases, etc.) and be used to interface with third-party resources.

Extensions 244 to the domain framework 250 can be constructed to help interface the domain framework 250 to the application data managers 240. The extensions can be standardized for use across multiple different applications, and collected into a library. As such, the extensions may be pluggable and removable as desired. The extensions 244 may reside in either or both the data coordination layer 206 and the data abstraction layer 208, as represented by the block 244 straddling both layers.

The data abstraction layer 208 further includes a persistence management module 252 to manage data persistence in cooperation with the underlying data storage resources, and a bulk data access module 254 to facilitate access to data storage resources. Due to the partitioned nature of the architecture 110, the data abstraction layer 208 isolates the business logic layer 204 and the data coordination layer 206 from the underlying resources 108, allowing such mechanisms from the persistence management module 252 to be plugged into the architecture as desired to support a certain type of resource without alteration to the execution models 230 or application data managers 240.

A service layer 210 interfaces the data abstraction layer 208 and the resources 108. The service layer 210 contains service software modules for facilitating communication with specific underlying resources. Examples of service software modules include a logging service, a configuration service, a serialization service, a database service, and the like.

The presentation layer 212 contains the software elements that package and deliver the replies to the clients. It handles such tasks as choosing the content for a reply, selecting a data format, and determining a communication protocol. The presentation layer 212 also addresses the “look and feel” of the application by tailoring replies according to a brand and user-choice perspective. The presentation layer 212 is partitioned from the business logic layer 204 of the application. By separating presentation aspects from request processing, the architecture 110 enables the application to selectively render output based on the types of receiving devices without having to modify the logic source code at the business logic layer 204 for each new device. This allows a single application to provide output for many different receiving devices (e.g., web browsers, WAP devices, PDAs, etc.) and to adapt quickly to new devices that may be added in the future.

In this implementation, the presentation layer 212 is divided into two tiers: a presentation tier and a content rendering tier. The request dispatcher 224 implements the presentation tier. It selects an appropriate data type, encoding format, and protocol in which to output the content so that it can be carried over a network and rendered on the client. The request dispatcher 224 is composed of an engine 262, which resides at the framework 220 in the illustrated implementation, and multiple request dispatcher types (RDTs) 264 that accommodate many different data types, encoding formats, and protocols of the clients. Based on the client device, the engine 262 makes various decisions relating to presentation of content on the device. For example, the engine might select an appropriate data encoding format (e.g. HTML, XML, EDI, WML, etc.) for a particular client and an appropriate communication protocol (e.g. HTTP, Java™ RMI, CORBA, TCP/IP, etc.) to communicate the response to the client. The engine 262 might further decide how to construct the reply for visual appearance, such as selecting a particular layout, branding, skin, color scheme, or other customization based on the properties of the application or user preference. Based on these decisions, the engine 262 chooses one or more dispatcher types 264 to structure the reply.

A content renderer 260 forms the content rendering tier of the presentation layer 212. The renderer 260 performs any work related to outputting the content to the user. For example, it may construct the output display to accommodate an actual width of the user's display, elect to display text rather than graphics, choose a particular font, adjust the font size, determine whether the content is printable or how it should be printed, elect to present audio content rather than video content, and so on.

With the presentation layer 212 partitioned from the execution environment 202, the architecture 110 supports receiving requests in one format type and returning replies in another format type. For example, a user on a browser-based client (e.g., desktop or laptop computer) may submit a request via HTTP and the reply to that request may be returned to that user's PDA or wireless communications device using WAP. Additionally, by partitioning the presentation layer 212 from the business logic layer 204, the presentation functionality can be modified independently of the business logic to provide new or different ways to serve the content according to user preferences and client device capabilities.

The architecture 110 may include one or more other layers or modules. One example is an authentication model 270 that performs the tasks of authenticating clients and/or users prior to processing any requests. Another example is a security policy enforcement module 280 that supports the security of the application. The security enforcement module 280 can be implemented as one or more independent modules that plug into the application framework to enforce essentially any type of security rules. New application security rules can be implemented by simply plugging in a new system enforcement module 280 without modifying other layers of the architecture 110.

General Operation

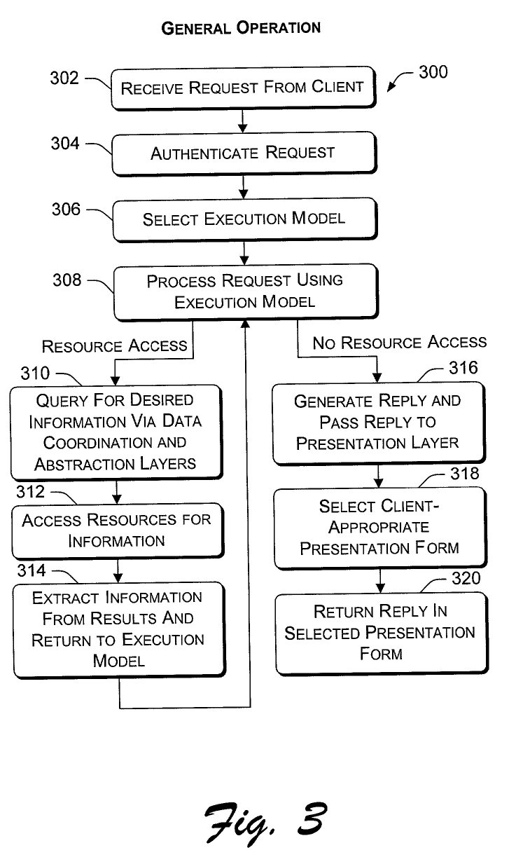

FIG. 3 shows an exemplary operation 300 of a business domain application constructed using the architecture 110 of FIGS. 1 and 2. The operation 300 is implemented as a software process of acts performed by execution of software instructions. Accordingly, the blocks illustrated in FIG. 3 represent computer-readable instructions, that when executed at the server system 106, perform the acts stipulated in the blocks.

To aid the discussion, the operation will be described in the context of asset management, wherein the architecture 110 is configured as a server application executing on the application server system 106 for an asset management domain. Additionally, for discussion purposes, suppose a user is equipped with a portable wireless communications device (e.g., a cellular phone) having a small screen with limited display capabilities and utilizing WAP to send/receive messages over a wireless cellular network. The user submits a request for information on a particular asset, such as the specification of a turbine engine or the availability of an electric pump, from the wireless communications device.

At block 302, requests from various clients are received at the execution environment layer 202. Depending on the client type, one or more adapters 228 may be involved to receive the requests and convert them to a form used internally by the application 110. In our example, the execution environment layer 202 receives the request from the wireless cellular network. An adapter 228 may be utilized to unwrap the request from its WAP-based packet for internal processing.

At block 304, the execution framework 202 may pass the request, or data extracted from the request, to the authentication model 270 for authentication of the client and/or user. If the requester is not valid, the request is denied and a service denied message (or other type of message) is returned to the client. Assuming the request is valid, the authentication model 270 returns its approval.

At block 306, the model dispatcher 222 routes the request to one or more execution models 230 in the business logic layer 204 to process the client request. In our example, the model dispatcher 222 might select selects an execution model 230 to retrieve information on the particular asset. A translator 226 may be invoked to assist in conforming the request to a form that is acceptable to the selected execution model.

At block 308, the execution model 230 begins processing the request. Suppose, for example, that the selected execution model is implemented as a command bean model in which individual code sequences, or “command beans”, perform discrete tasks. One discrete task might be to initiate a database transaction, while another discrete task might be to load information pertaining to an item in the database, and a third discrete task might be to end the transaction and return the results.

The execution model 230 may or may not need to access information maintained at an external resource. For simple requests, such as an initial logon page, the execution model 230 can prepare a reply without querying the resources 108. This is represented by the “No Resource Access” branch in FIG. 3. For other requests, such as the example request for data on a particular asset, the execution model may utilize information stored at an external resource in its preparation of a reply. This is illustrated by the “Resource Access” branch.

When the execution model 230 reaches a point where it wishes to obtain information from an external resource (e.g., getting asset specific information from a database), the execution model calls an application data manager 240 in the data coordination layer 206 to query the desired information (i.e., block 310). The application data manager 240 communicates with the domain framework 250 in the data abstraction layer 208, which in turn maps the query to the appropriate resource and facilitates access to that resource via the service layer 210 (i.e., block 312). In our example, the domain framework is configured with an asset management domain object model that controls information flow to external resources-storage systems, inventory systems, etc.-that maintain asset information.

At block 314, results are returned from the resource and translated at the domain framework 250 back into a raw form that can be processed by the execution model 230. Continuing the asset management example, a database resource may return specification or availability data pertaining to the particular asset. This data may initially be in a format used by the database resource. The domain framework 250 extracts the raw data from the database-formatted results and passes that data back through the application data managers 240 to the execution model 230. In this manner, the execution model 230 need not understand how to communicate with the various types of resources directly, nor understand the formats employed by various resources.

At block 316, the execution model completes execution using the returned data to produce a reply to the client request. In our example, the command bean model generates a reply containing the specification or availability details pertaining to the requested asset. The execution model 230 passes the reply to the presentation layer 212 to be structured in a form that is suitable for the requesting client.

At block 318, the presentation layer 212 selects an appropriate format, data type, protocol, and so forth based on the capabilities of the client device, as well as user preferences. In the asset management example, the client device is a small wireless communication device that accepts WAP-based messages. Accordingly, the presentation layer 212 prepares a text reply that can be conveniently displayed on the small display and packages that reply in a format supported by WAP. At block 320, the presentation layer 212 transmits the reply back to the requesting client using the wireless network.

Business Logic Layer

The business logic layer 204 contains one or more execution models that define how computer programs process client requests received by the application. One exemplary execution model employs an interaction-based definition in which computer programs are individually defined by a series of one or more interaction definitions based on a request-response model. Each interaction definition includes command definitions and view definitions. A command definition defines a command whose functionality may be represented by an object that has various attributes and that provides the behavior for that command. A view definition defines a view that provides a response to a request.

Each interaction of a computer program is associated with a certain type of request. When a request is received from the model dispatcher 222, the associated interaction is identified to perform the behavior of the commands defined by that interaction. The execution model automatically instantiates an object associated with each command defined in a command definition. Prior to performing the behavior of a command, the execution model prepares the instantiated object by identifying one or more input attributes of that object (e.g., by retrieving the class definition of the object) and setting the input attributes (e.g., by invoking set methods) of the object based on the current value of the attributes in an attribute store.

After setting the attribute values, the execution model performs the behavior of the object (e.g., by invoking a perform method of the object). After the behavior is performed, the execution model extracts the output attributes of the object by retrieving the values of the output attributes (e.g., by invoking get methods of the object) and storing those values in the attribute store. Thus, the attribute store stores the output attributes of each object that are then available to set the input attributes of other objects.

The execution model may serially perform the instantiation, preparation, performance, and extraction for each command. Alternatively, the execution of commands can be performed in parallel depending on the data dependencies of the commands. Because the execution model automatically prepares an object based on the current values in the attribute store and extracts attribute values after performing the behavior of the object, a programmer does not need to explicitly specify the invocation of methods of objects (e.g., “object.setAttribute1=15”) when developing a computer program to be executed by the execution model.

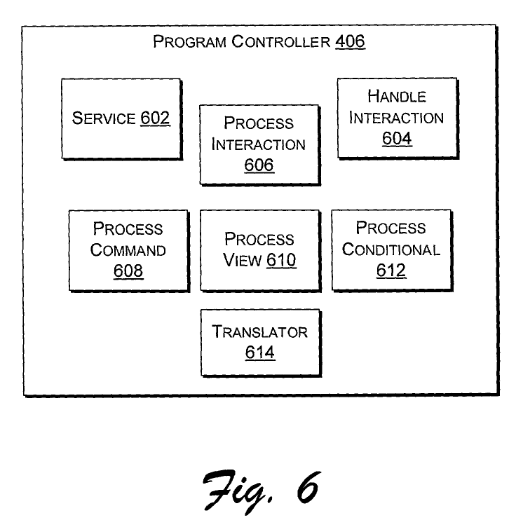

FIG. 4 shows an exemplary execution model 230 configured for an asset catalog application that allows a user to view, create, and modify information relating to assets (e.g., products) stored in an electronic catalog. The model 230 includes an asset catalog program 402, an attribute store 404, and a program controller 406. The asset catalog program 402 includes eight interactions: login 410, do-login 412, main-menu 414, view-asset 416, create-asset 418, do-create-asset 420, modify-asset 422, and do-modify-asset 424. The controller 406 executes the program 402 to perform the various interactions. One exemplary implementation of the controller is described below in more detail with reference to FIG. 6.

Upon receiving a request, the controller 406 invokes the corresponding interaction of the program 402 to perform the behavior and return a view so that subsequent requests of the program can be made. The do-create-asset interaction 420, for example, is invoked after a user specifies the values of the attributes of a new asset to be added to the asset catalog. Each interaction is defined by a series of one or more command definitions and a view definition. Each command definition defines a command (e.g., object class) that provides a certain behavior. For instance, the do-create-asset interaction 420 includes five command definitions—application context 430, begin transaction 432, compose asset 434, store object 436, and end transaction 438—and a view definition named view asset 440.

When the do-create-asset interaction 420 is invoked, the application context command 430 retrieves the current application context of the application. The application context may be used by the interaction to access certain application-wide information. The begin transaction command 432 indicates that a transaction for the asset catalog is beginning. The compose asset command 434 creates an object that identifies the value of the attributes of the asset to be added to the asset catalog. The store object command 436 stores an entry identified by the created object in the asset catalog. The end transaction command 438 indicates that the transaction to the asset catalog has ended. The view asset view 440 prepares a response (e.g., display page) to return to the user.

The attribute store 404 contains an entry for each attribute that has been defined by any interaction of the application that has been invoked. The attribute store identifies a name of the attribute, a type of the attribute, a scope of the attribute, and a current value of the attribute. For example, the last entry in the attribute store 404 has the name of “assetPrice”, with a type of “integer”, a value of “500,000”, and a scope of “interaction”. The scope of an attribute indicates the attribute's life. An attribute with the scope of “interaction” (also known as “request”) has a life only within the interaction in which it is defined. An attribute with the scope of “session” has a life only within the current session (e.g., logon session) of the application. An attribute with the scope of “application” has life throughout the duration of an application.

When the program controller 406 receives a request to create an asset (e.g., a do-create-asset request), the controller invokes the do-create-asset interaction 420. The controller first instantiates an application context object defined in the interaction command 430 and prepares the object by setting its attributes based on the current values of the attribute store 404. The controller then performs the behavior of the object by invoking a perform method of the object and extracts the attribute values of the object by getting the attribute values and storing them in the attribute store 404.

Next, the program controller 406 instantiates a begin transaction object defined by the interaction command 432 and prepares the object by setting its attribute values based on the current values of the attribute store 404. It then performs the behavior of the object by invoking a perform method of the object and extracts the attribute values of the object by getting the attribute values and storing them in the attribute store. The controller 406 repeats this process for a compose-asset object instantiated according to command 434, the store-object object instantiated according to command 436, and the end transaction object instantiated according to command 438. The controller 406 then invokes the view asset 440 to retrieve the values of the attributes of the asset from the attribute store 404 for purposes of presenting those attribute values back to the client.

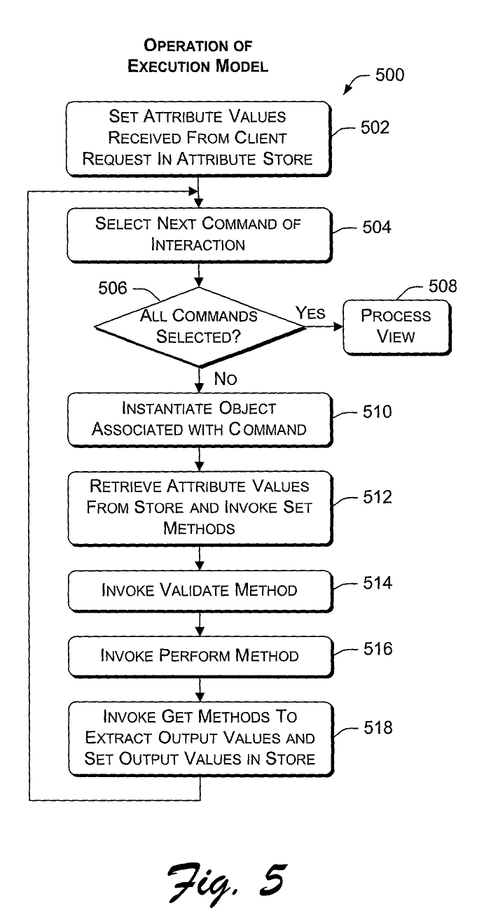

FIG. 5 shows a process 500 implemented by the program controller 406 of the execution model 230 when executing an interaction-based program, such as program 402. The process 500 is implemented in software and hence, the illustrated blocks represent computer-readable instructions, that when executed at the server system 106, perform the stated acts.

At block 502, the controller 406 sets the attribute values from the request in the attribute store 404. For example, a view-asset request may include a value for an “assetID” attribute that uniquely identifies an asset currently stored in the asset catalog. The controller then loops through each command of the interaction associated with the request. At block 504, the controller selects the next command of the interaction associated with the request, starting with the first command. If all commands have already been selected (i.e., the “yes” branch from block 506), the controller 406 processes the view defined in the view definition of the interaction and returns the response to the presentation layer 212 (i.e., block 508).

On the other hand, if not all of the commands have been selected (i.e., the “no” branch from block 506), the controller instantiates an object associated with the selected command (i.e., block 510). The object class associated with the command is specified in the command definition of the interaction. In block 512, the controller 406 prepares the object by retrieving the values of the input attributes of the object from the attribute store 404 and invoking the set methods of the object to set the values of the attributes. At block 514, the controller invokes a validate method of the object to determine whether the current values of the input attributes of the object will allow the behavior of the object to be performed correctly. If the validate method indicates that the behavior cannot be performed, the controller generates an exception and skips further processing of the commands of the interaction.

At block 516, the controller invokes the perform method of the object to perform the behavior of the object. At block 518, the controller extracts the values of the output attribute of the object by invoking the get methods of the object and setting the values of the corresponding attributes in the attribute store 404. The controller then loops to block 504 to select the next command of the interaction.

FIG. 6 shows one exemplary implementation of the controller 406 in more detail. It includes multiple components that are configured according to the request-response model where individual components receive a request and return a response. The controller 406 includes a service component 602 that is invoked to service a request message. The service component 602 stores the value of any attributes specified in the request in the attribute store 404. For example, the component may set the current value of a URL attribute as indicated by the request. Once the attribute values are stored, the service component 602 invokes a handle interaction component 604 and passes on the request. It is noted that the service component will eventually receive a response in return from the handle interaction component 604, which will then be passed back to the presentation layer 212 for construction of a reply to be returned to the client.

The handle interaction component 604 retrieves, from the program database, the interaction definition for the interaction specified in the request. The handle interaction component 604 then invokes a process interaction component 606 and passes the request, response, and the interaction definition.

The process interaction component 606 processes each command and view of the interaction and returns a response. For a given descriptor (i.e., command, view, or conditional) specified in the interaction, the process interaction component identifies the descriptor and invokes an appropriate component for processing. If the descriptor is a command, the process interaction component 606 invokes a process command component 608 to process the command of interaction. If the descriptor is a view, the process interaction component 606 invokes a process view component 610 to process the view of the interaction. If the descriptor is a conditional, the process interaction component 606 invokes a process conditional component 612 to process the conditional of the interaction.

When processing a command, the process command component 608 instantiates the object (e.g., as a “Java bean” in the Java™ environment) for the command and initializes the instantiated object by invoking an initialization method of the object. The process command component invokes a translator component 614 and passes the instantiated object to prepare the object for performing its behavior. A translator component is an object that provides a prepare method and an extract method for processing an object instantiated by the process command component to perform the command. Each command may specify the translator that is to be used for that command. If the command does not specify a translator, a default translator is used.

The translator component 614 sets the attribute values of the passed object based on the current attribute values in the attribute store 404. The translator component 614 identifies any set methods of the object based on a class definition of the object. The class definition may be retrieved from a class database or using a method provided by the object itself. When a set method is identified, the translator component identifies a value of the attribute associated with a set method of the object. The attribute store is checked to determine whether a current value for the attribute of the set method is defined. If the current value of the attribute is defined in the attribute store, the attribute value is retrieved from the attribute store, giving priority to the command definition and then to increasing scope (i.e., interaction, session, and then application). The component performs any necessary translation of the attribute value, such as converting an integer representation of the number to a string representation, and passes back the translated value. When all methods have been examined, the translator component 614 returns control to the process command component 608.

The process command component 608 may also validate the object. If valid, the component performs the behavior of the object by invoking the perform method of the object. The component once again invokes the translator and passes the object to extract the attribute values of the object and store the current attribute values in the attribute store 404.

When processing a view, the process view component 610 either invokes a target (e.g., JSP, ASP, etc.) or invokes the behavior of an object that it instantiates. If a class name is not specified in the definition of the view, the process view component 610 retrieves a target specified in the view definition and dispatches a view request to the retrieved target. Otherwise, if a class name is specified, the process view component 610 performs the behavior of an object that it instantiates. The process view component 610 retrieves a translator for the view and instantiates an object of the type specified in the view definition. The process view component 610 initializes the object and invokes the translator to prepare the object by setting the values of the attributes of the object based on the attribute store. The process view component 610 validates the object and performs the behavior of the object. The process view component 610 then returns.

When processing a conditional, the process conditional component 612 interprets a condition to identify the descriptors that should be processed. The component may interpret the condition based on the current values of the attributes in the attribute store. Then, the process conditional component 612 recursively invokes the process interaction component 606 to process the descriptors (command, view, or conditional) associated with the condition. The process conditional component 612 then returns.

One exemplary form of a program implemented as a document type definition (DTD) is illustrated in Table 1. The interactions defining the program are specified in an XML (“Extensible Markup Language”) file.

TABLE 1

| 1. | <!ELEMENT program (translator*,command*,view*,interaction*)> | |
|---|---|---|
| 2. | <!ATTLIST program | |
| 3. | name | ID #REQUIRED |
| 4. | > | |
| 5. | | |
| 6. | <!ELEMENT translator EMPTY> | |
| 7. | <!ATTLIST translator | |
| 8. | name | ID #REQUIRED |
| 9. | class | CDATA #REQUIRED |
| 10. | default | (true\|false) “false” |

| 11. | > | |
|---|---|---|
| 12. | | |
| 13. | <!ELEMENT translator-ref EMPTY> | |
| 14. | <!ATTLIST translator-ref | |
| 15. | name | IDREF #REQUIRED |

| 16. | > | |
|---|---|---|
| 17. | | |
| 18. | <!ELEMENT command (translator-ref*, attribute*)> | |
| 19. | <!ATTLIST command | |
| 20. | name | ID #REQUIRED |
| 21. | class | CDATA #REQUIRED |

| 22. | > | |
|---|---|---|
| 23. | | |
| 24. | <!ELEMENT command-ref (attribute*)> | |
| 25. | <!ATTLIST command-ref | |
| 26. | name | IDREF #REQUIRED |

| 27. | type | (default\|finally) “default” |
|---|---|---|
| 28. | > | |
| 29. | | |
| 30. | <!ELEMENT attribute EMPTY> | |
| 31. | <!ATTLIST attribute | |
| 32. | name | ID #REQUIRED |
| 33. | value | CDATA #IMPLIED |
| 34. | get-name | CDATA #IMPLIED |
| 35. | set-name | CDATA #IMPLIED |
| 36. | scope | (application\|request\|session) “request” |
| 37. | > | |
| 38. | | |
| 39. | <!ELEMENT view> | |
| 40. | <!ATTLIST view | |
| 41. | name | ID #REQUIRED |
| 42. | target | CDATA #REQUIRED |
| 43. | type | (default\|error) “default” |
| 44. | default | (true\|false) “false” |

| 45. | > | |
|---|---|---|
| 46. | | |
| 47. | <!ELEMENT view-ref> | |
| 48. | <!ATTLIST view-ref | |
| 49. | name | IDREF #REQUIRED |

| 50. | > | |
|---|---|---|
| 51. | | |
| 52. | <!ELEMENT if(#PCDATA)> | |
| 53. | <!ELEMENT elsif(#PCDATA)> | |
| 54. | <!ELEMENT else EMPTY> | |
| 55. | <!ELEMENT conditional (if?, elsif*, else*, command-ref*, view-ref*, conditional*)> | |
| 56. | | |
| 57. | !ELEMENT interaction (command-ref*,view-ref*,conditional*)> | |
| 58. | <!ATTLIST interaction | |
| 59. | name | ID #REQUIRED |
| 60. | > | |

Lines 1-4 define an program tag, which is the root tag of the XML file. The program tag can include translator, command, view, and interaction tags. The program tag includes a name attribute that specifies the name of the program. Lines 6-11 define a translator tag of the translator, such as translator 614. The name attribute of the translator tag is a logical name used by a command tag to specify the translator for that command. The class attribute of the translator tag identifies the class for the translator object. The default attribute of the translator tag indicates whether this translator is the default translator that is used when a command does not specify a translator.

Lines 13-16 define a translator-ref tag that is used in a command tag to refer back to the translator to be used with the command. The name attribute of the translator-ref tag identifies the name of the translator to be used by the command. Lines 18-22 define a command tag, which may include translator-ref tags and attribute tags. The translator-ref tags specify names of the translators to be used by this command and the attribute tags specify information relating to attributes of the command. The name attribute of the command tag provides the name of the command. The class attribute of the command tag provides the name of the object class that provides the behavior of the command.

Lines 24-28 define a command-ref tag that is used by an interaction tag (defined below) to specify the commands within the interaction. The command reference tag may include attribute tags. The name attribute of the command-ref tag specifies the logical name of the command as specified in a command tag. The type attribute of the command-ref tag specifies whether the command should be performed even if an exception occurs earlier in the interaction. The value of “finally.” means that the command should be performed.

Lines 30-37 define an attribute tag, which stipulates how attributes of the command are processed. The name attribute of the attribute tag specifies the name of an attribute. The value attribute of the attribute tag specifies a value for the attribute. That value is to be used when the command is invoked to override the current value for that attribute in the attribute store. The get-name attribute of the attribute tag specifies an alternate name for the attribute when getting an attribute value. The set-name attribute of the attribute tag specifies an alternate name for the attribute when setting an attribute value. The scope attribute of the attribute tag specifies whether the scope of the attribute is application, request (or interaction), or session.

Lines 39-45 define a view tag that stipulates a view. The name attribute of the view tag specifies the name of the view. The target attribute of a view tag specifies the JSP target of a view. The type attribute of the view tag specifies whether the view should be invoked when there is an error. The default attribute of the view tag specifies whether this view is the default view that is used when an interaction does not explicitly specify a view.

Lines 47-50 define a view-ref tag, which is included in interaction tags to specify that the associated view is to be included in the interaction. The name attribute of the view-ref tag specifies the name of the referenced view as indicated in a view tag. Lines 52-55 define tags used for conditional analysis of commands or views. A conditional tag may include an “if” tag, an “else if” tag, an “else” tag, a command-ref tag, a view-ref tag, and a conditional tag. The data of the “if” tag and the “else if” tag specify a condition (e.g., based on attribute values in the attribute store) that defines the commands or view that are to be conditionally performed when executing interaction.

Lines 57-60 define an interaction tag, which defines a sequence of command, view, or conditional tags of an interaction. The interaction tag may include command-ref, view-ref and conditional tags. The name attribute of the interaction tag identifies the name of the interaction. The requests passed into the execution model specify the name of the interaction to execute.

Table 2 provides an example XML file for the asset catalog program 402 illustrated in FIG. 4 and described above. Line 1 includes a program tag with the name of the program “asset catalog”. Lines 2-3 specify the default translator for the program. Lines 5-11 define the various commands associated with the program. For example, as indicated by line 7, the command named “login” is associated with the class “demo.cb.Login.” Whenever a login command is performed, an object of class “demo.cb.Login” is used to provide the behavior.

Lines 13-20 define the views of the program. For example, line 14 illustrates that the view named “view-asset” (i.e., view 440 in FIG. 4) is invoked by invoking the target named “html/view-assetjsp.” Lines 23-119 define the various interactions that compose the program. For example, lines 42-53 define the view-asset interaction 416 as including command-ref tags for each command defined in the interaction. The conditional tag at lines 47-52 defines a conditional view such that if a login user has administrator permission, the “view-asset-admin” view is invoked; otherwise, the “view-asset” view is invoked. Lines 88-90 illustrate the use of an attribute tag used within a command tag. The attribute tag indicates that the attribute named “object” is an input attribute of the command that corresponds to the attribute named “asset” in the attribute store 404.

TABLE 2

| | |
|---|---|
| 1. | <program name=“asset catalog”> |
| 2. | <translator name=“default-trans” class=“com.ge.dialect.cb.DefaultTranslator” |
| 3. | default=“true”/> |
| 4. | |
| 5. | <command name=“app-ctx” class=“demo.cb.AppCtx”/> |
| 6. | <command name=“begin-tx” class=“demo.cb.BeginTx”/> |
| 7. | <command name=“login” class=“demo.cb.Login”/> |
| 8. | <command name=“load-asset” class=“demo.cb.LoadAsset”/> |
| 9. | <command name=“compose-asset” class=“demo.cb.ComposeAsset”/> |
| 10. | <command name=“store-object” class=“demo.cb.StoreObject”/> |
| 11. | <command name=“end-tx” class=“demo.cb.EndTx”/> |
| 12. | |
| 13. | <view name=“error-view” target=“html/error.jsp” type=“error” default=“true”/> |
| 14. | <view name=“view-asset” target=“html/view-asset.jsp”/> |
| 15. | <view name=“view-asset-admin” target=“html/view-asset-admin.jsp”/> |
| 16. | <view name=“create-asset” target=“html/create-asset.jsp”/> |
| 17. | <view name=“modify-asset” target=“html/modify-asset.jsp”/> |
| 18. | <view name=“login” target=“html/login.jsp”/> |
| 19. | <view name=“login-error” target=“html/login.jsp” type=“error”/> |
| 20. | <view name=“main-menu” target=“html/main-menu.jsp”/> |
| 21. | |
| 22. | |
| 23. | <interaction name=“login”> |

| | |
|---|---|
| 24. | <view-ref name=“login”/> |

| | |
|---|---|
| 25. | </interaction> |
| 26. | |
| 27. | <interaction name=“do-login”> |

| | |
|---|---|
| 28. | <command-ref name=“app-ctx”/> |
| 29. | <command-ref name=“begin-tx”/> |
| 30. | <command-ref name=“login”> |

| | |
|---|---|
| 31. | <attribute name=“loginUser” scope=“session”/> |

| | |
|---|---|
| 32. | </command-ref> |
| 33. | <command-ref name=“end-tx” type=“finally”/> |
| 34. | <view-ref name=“main-menu”/> |
| 35. | <view-ref name=“login-error”/> |

| | |
|---|---|
| 36. | </interaction> |
| 37. | |
| 38. | <interaction name=“main-menu”> |

| | |
|---|---|
| 39. | <view-ref name=“main-menu”/> |

| | |
|---|---|
| 40. | </interaction> |
| 41. | |
| 42. | <interaction name=“view-asset”> |

| | |
|---|---|
| 43. | <command-ref name=“app-ctx”/> |
| 44. | <command-ref name=“begin-tx”/> |
| 45. | <command-ref name=“load-asset”/> |
| 46. | <command-ref name=“end-tx” type=“finally”/> |
| 47. | <conditional> |

| | |
|---|---|
| 48. | <if>(loginUser != void) &amp;&amp; loginUser.hasPermission(“admin”)</if> |

| | |
|---|---|
| 49. | <view-ref name=“view-asset-admin”/> |

| | |
|---|---|
| 50. | <else/> |

| | |
|---|---|
| 51. | <view-ref name=“view-asset”/> |

| | |
|---|---|
| 52. | </conditional> |

| | |
|---|---|
| 53. | </interaction> |
| 54. | |
| 55. | <interaction name=“create-asset”> |

| | |
|---|---|
| 56. | <view-ref name=“create-asset”/> |

| | |
|---|---|
| 57. | </interaction> |
| 58. | |
| 59. | <interaction name=“do-create-asset”> |

| | |
|---|---|
| 60. | <command-ref name=“app-ctx”/> |
| 61. | <command-ref name=“begin-tx”/> |
| 62. | <command-ref name=“compose-asset”/> |
| 63. | <command-ref name=“store-object”> |

| | |
|---|---|
| 64. | <attribute name=“object” get-name=“asset”/> |

| | |
|---|---|
| 65. | </command-ref> |
| 66. | <command-ref name=“end-tx” type=“finally”/> |
| 67. | <conditional> |

| | |
|---|---|
| 68. | <if>(loginUser != void) &amp;&amp; loginUser.hasPermission(“admin”)</if> |

| | |
|---|---|
| 69. | <view-ref name=“view-asset-admin”/> |

| | |
|---|---|
| 70. | <else/> |

| | |
|---|---|
| 71. | <view-ref name=“view-asset”/> |

| | |
|---|---|
| 72. | </conditional> |

| | |
|---|---|
| 73. | </interaction> |
| 74. | |
| 75. | <interaction name=“modify-asset”> |

| | |
|---|---|
| 76. | <command-ref name=“app-ctx”/> |
| 77. | <command-ref name=“begin-tx”/> |
| 78. | <command-ref name=“load-asset”/> |
| 79. | <command-ref name=“end-tx” type=“finally”/> |
| 80. | <view-ref name=“modify-asset”/> |

| | |
|---|---|
| 81. | <interaction> |
| 82. | |
| 83. | <interaction name=“do-modify-asset”> |

| | |
|---|---|
| 84. | <command-ref name=“app-ctx”/> |
| 85. | <command-ref name=“begin-tx”/> |
| 86. | <command-ref name=“load-asset”/> |
| 87. | <command-ref name=“compose-asset”/> |
| 88. | <command-ref name=“store-object”> |

| | |
|---|---|
| 89. | <attribute name=“object” get-name=“asset”/> |

| | |
|---|---|
| 90. | </command-ref> |
| 91. | <command-ref name=“end-tx” type=“finally”/> |
| 92. | <conditional> |

| | |
|---|---|
| 93. | <if>(loginUser != void) &amp;&amp; loginUser.hasPermission(“admin”)</if> |

| | |
|---|---|
| 94. | <view-ref name=“view-asset-admin”/> |

| | |
|---|---|
| 95. | <else/> |

| | |
|---|---|
| 96. | <view-ref name=“view-asset”/> |

| | |
|---|---|
| 97. | </conditional> |

| | |
|---|---|
| 98. | </interaction> |
| 99. | |
| 100. | |
| 101. | <interaction name=“view-error2”> |

| | |
|---|---|
| 102. | <conditional> |

| | |
|---|---|
| 103. | <if>“A”.equals(“B”)</if> |

| | |
|---|---|
| 104. | <command-ref name=“begin-tx”/> |
| 105. | <command-ref name=“load-asset”/> |
| 106. | <command-ref name=“end-tx” type=“finally”/> |

| | |
|---|---|
| 107. | <elsif>“NEVER”.equals(“EQUAL”)</elsif> |

| | |
|---|---|
| 108. | <command-ref name=“load-asset”/> |
| 109. | <command-ref name=“end-tx” type=“finally”/> |

| | |
|---|---|
| 110. | </conditional> |

| | |
|---|---|
| 111. | <view-ref name=“view-asset”/> |

| | |
|---|---|
| 112. | </interaction> |
| 113. | |
| 114. | |
| 115. | <interaction name=“view-error”> |

| | |
|---|---|
| 116. | <command-ref name=“load-asset”/> |
| 117. | <command-ref name=“end-tx” type=“finally”/> |
| 118. | <view-ref name=“view-asset”/> |

| | |
|---|---|
| 119. | <interaction> |
| 120. | |
| 121. | </program> |

Presentation Layer

The presentation layer 212 facilitates delivery of the responses produced by the business logic layer 204 back to the client devices. The presentation layer 212 enables the server application to selectively render output based on the type of receiving device, such as web browsers, WAP devices, PDAs, and other computing devices. This layer also addresses what the “look and feel” of an application is from a brand and user-choice perspective.

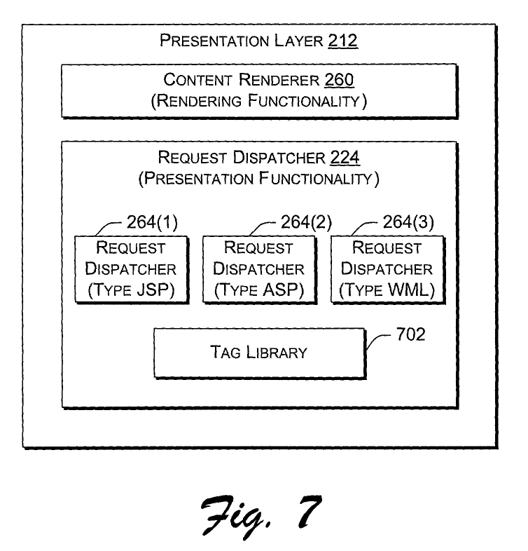

FIG. 7 illustrates the presentation layer 212 in more detail. The presentation layer 212 is itself a composite of two tiers that generally separate presentation functionality from rendering functionality. The partitioning of presentation from rendering permits developers to design separate solutions for how content is presented to users and how content is physically output to achieve that presentation.

The request dispatcher 224 implements the presentation functionality by performing any logic associated with choosing which data or content to be displayed, performing any transformations or manipulations of the data or content, and selecting an output format appropriate to the conditions, preferences, and properties of the user. For instance, the request dispatcher 224 picks which content to return in the reply to the client, such as whether the reply should include such content as branding logos (i.e., company, sponsors, etc.), advertising banners, notices, legal terms, and so on. The request dispatcher further decides the layout of the content, such as where to position the various elements, or whether to use tables or charts. The request dispatcher 224 may also determine an appropriate color scheme or whether to impose an overall “skin” theme that dictates a color pallet and appearance to the presented content. The dispatcher 224 may make such decisions and other customizations based on the capabilities of the client device, preferences of the user, and properties of the application.

The request dispatcher 224 also selects the appropriate encoding format for the particular client device. For a browser-enabled client, the dispatcher may select to encode the content using HTML. If the client is a wireless communications device, perhaps the dispatcher elects to encode the content using WML (Wireless Markup Language). Other possible formats include XML (extensible markup language), EDI (electronic data interchange), etc.

Also contributing to the presentation functionality implemented by the request dispatcher 224 is the selection of an appropriate communication protocol for communicating the reply to the client. The request dispatcher may elect to use HTTP and/or TCP/IP to send the reply to the browser-enabled client. For a wireless communication device, the request dispatcher 224 may employ WAP to send the reply. Other possible protocols include Java™ RMI (Remote Method Invocation), CORBA (Common Object Request Broker Architecture), etc.

The request dispatcher 224 implements one or more request dispatcher types 264 that implement specific types of presentation functionality. As one example implementation, FIG. 7 shows three request dispatcher types 264(1), 264(2), and 264(3). The first request dispatcher type 264(1) is configured to structure replies using Java server pages (JSPs). JSP is an HTML page with embedded Java™ source code that is executed at the server system. The HTML provides the page layout that will be returned to the client's web browser, and the code provides the presentation processing to fill in the page with content. The second request dispatcher type 264(2) is configured to generate responses using Active server pages (ASP), a technology from Microsoft Corporation that allows for dynamic creation of web pages. The third request dispatcher type 264(3) is configured to generate responses using WML technology.

The request dispatcher type 264 may access a tag library 702 to retrieve preformed HTML tags for convenient and efficient construction of a response page. The tag library 702 contains various tags that adapt to various device formats and protocols, as well as different languages. In this way, a single code base can be used to ensure a correct format for multiple languages, to selectively render output based on the type of device that is receiving the output of the application, and so forth.

The presentation layer 212 further includes a content renderer 260 that implements the rendering functionality. The content renderer 260 performs any work related to the output, display, formatting, printing, etc., of the content to the user. The content renderer 260 may make logical decisions based on the content and user or system preferences, but such logical decisions are restricted to the actual rendering of the data or content. For instance, the content renderer 260 constructs the output display to accommodate the actual size of the user's display. A web page produced by the request dispatcher may be sized differently depending upon whether the page is being served to a 21″ CRT monitor for a desktop computer or to a small 4″ LCD screen for a handheld device.

The content renderer 260 may also decide how to display the content, making such decisions as whether text should be color or black and white, whether graphics can be supported, and so forth. The content renderer 260 may also manipulate font selections to ensure readability at the client device. These decisions may be based on the client device capabilities, or on user preferences. For example, a vision-impaired user may prefer larger font size than other users.

The dual-tier architecture may be implemented according to different software techniques. In one implementation, the tiers may be implemented as a proprietary protocol or an application program interface (API). For instance, an API may be used to interface the content renderer 260 and the request dispatcher types 264 with the framework-based engine 262 of the execution environment (FIG. 2). The execution environment could then make calls into the presentation and rendering tiers via the API, passing in the processed results and the any desired parameters regarding layout, color, themes, protocols, formats, and so forth. The content renderer 260 and request dispatchers 264 would then structure and return the replies in the desired form. In another implementation, the presentation layer 212 may be configured as a highly interoperable extension of an existing platform, such as the J2EE (Java 2, Enterprise Edition) platform. In this case, the presentation layer 212 could delegate certain of the rendering activities to existing technology, such as JSP, while performing the presentation functions as described.

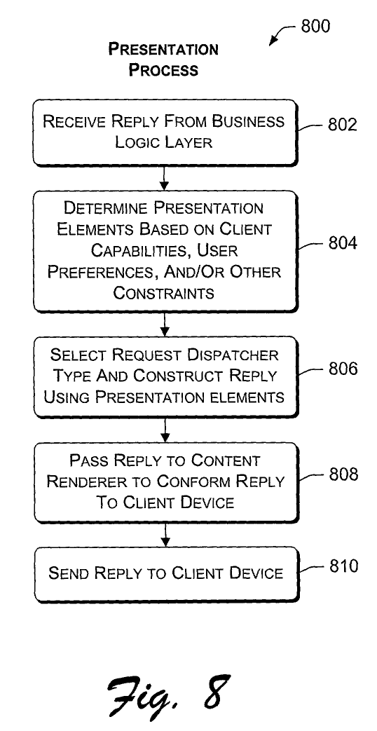

FIG. 8 shows a process 800 for structuring replies in a presentation form that accommodates client device capabilities and user preferences. The process 800 is implemented in software and hence, the illustrated blocks represent computer-readable instructions, that when executed at the server system 106, perform the stated acts.

At block 802, a reply is received from the business logic layer 204. The reply is produced as a result of processing a request received from a client. At this point, the reply can be in the form of raw data being returned from the execution model 230. For instance, the reply may be a description of an asset, or a quote on a financial instrument, or a confirmation of an order, or practically anything.

The reply is received initially at the execution environment 202, which originally routed the client request to the business logic layer 202. More particularly, the reply is routed to the request dispatcher 224.

At block 804, the request dispatcher 224 determines the presentation elements of the reply. This might include the layout, color scheme, branding logos, notices, and so forth. The determination may be based on the client capabilities, the user's preferences, and/or other constraints. Once the presentation elements are determined, the request dispatcher 224 (or more specifically, the engine 262) selects a request dispatcher type 264 to structure the reply with the presentation elements (i.e., block 806). The request dispatcher type 264 further encodes the reply according to the desired encoding format and communication protocol for the specific client device.

At block 808, the reply is passed to the content renderer 260, which makes any further modifications to adapt the reply for specific output at the client. For instance, the content renderer 260 might adjust size, convert from color to black and white, or make other alterations to suite different display types of the client devices. At block 810, the properly constructed reply is returned to the client device for presentation to the user.

The tiered structure of the presentation layer is beneficial in that it allows convenient and adaptable support of multiple client types without modification of the business logic. With a tiered presentation layer, presentation functions pertaining to user preferences (e.g., color schemes, layout, etc.) can be handled independently of the specific rendering tasks demanded by client device capabilities.

Constraint Hierarchy

One beneficial aspect of the multi-layered application architecture 110 is that it can be configured to implement and enforce constraints that customize the behavior of the application. The constraints can be imposed by a variety of sources, with each source carrying a different priority. For instance, when creating an e-business application that can be accessed worldwide, there are a number of constraints that may be employed. A user may express preferences for how content is displayed. Customs of the user's locale may impose their own preferences, such as the addition of branding information and changes to icons, colors, themes, etc., to convey an overall business identity. An application service provider may require that certain disclaimers or advertising be present. Additionally, there may be legal restrictions imposed by government entities on the information that is accessible or viewable by a user of the system.

Currently, changes are made directly to application source code to implement such constraints. However, the architecture 110 can allow different constraints to be added or removed from an application independently of the business logic or other source code for the application. The architecture supports a hierarchy of constraint layers, where each constraint layer imposes different constraints on how the application might operate or how content may be presented to the user.

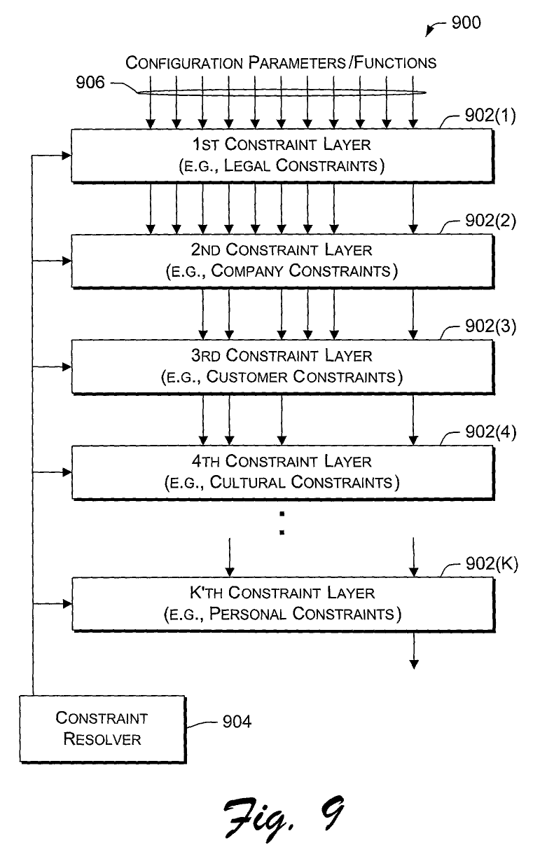

FIG. 9 shows an exemplary constraint hierarchy 900 composed of multiple constraint layers 902(1), 902(2), . . . , 902(K). Each constraint layer contains a set of constraints that are placed on various configuration parameters and application functions of the application. The constraints may be imposed from many different sources (e.g., legal, government, company, customer, user, etc.). Hence, each constraint layer may be viewed as representing a different source that controls or customizes how the application appears or operates.

The constraint layers 902 are organized so that higher-level constraint layers effectively limit or constrain lower-level constraint layers. For instance, the constraints imposed by top layer 902(1) effectively carry through to all lower layers 902(2)-902(K). Each constraint sets forth a set of metadata specifying preferred presentation and operation functionality. For instance, the metadata might suggest preferences for how content is presented (e.g., color, images, branding, terms and conditions, etc.). The constraint metadata might also control non-presentation aspects, such as logging and auditing functions, wherein the metadata specifies types of logins utilized for different users, regions, or departments. The metadata may also act as a filter to prevent certain operations or presentation features from occurring.

A constraint resolver 904 resolves the constraints at run time, or prior to run time, so that the application behaves and appears appropriately for the given set of constraints. With respect to presentation constraints, for example, the resolver 904 may use the metadata to identify or produce suitable tags used for coding an HTML or XML Web page in a manner that satisfies the constraint criteria. The constraint resolver 904 reconciles any conflicts among constraints imposed by different layers. In one implementation, the conflicts are resolved in favor of the higher-level layer so that constraints imposed by the higher-level layer effectively limits the lower-level layer, but not vice versa.

Once resolved, the constraint hierarchy 900 may reside in any one of many places in the architecture 110. It may reside in the execution environment 202 or the presentation layer 212. It may further reside as a separate layer, akin to the authentication model 270 and security policy enforcement module 280. The constraint hierarchy 900 may be implemented as a module that is readily added or removed from the architecture, perhaps as a DLL (dynamic link library) file. Alternatively, it may be a global document (e.g., an XML document) that resides remotely from the application, but is accessible by the application to determine how certain operations are to be performed for a given group of parties and conditions.

One example set of constraints is illustrated in FIG. 9. These constraints are arranged as a hierarchy of five constraint layers-legal, corporate, customer, cultural, and user. Prior to being constrained, the server application offers many different configuration parameters and application functions that may be individually selected or combined. These parameters and functions are illustrated as arrows 906 into top constraint layer 902(1).

In this example, the uppermost constraint layer 902(1) contains legally mandated constraints that dictate a certain behavior based on legal issues. Suppose, for example, that the legal constraint layer 902(1) specifies that all login pages carry a legal notice that only authorized employees and registered customers are permitted to login to the application. Due to the hierarchical nature, this legal constraint is applied to the login screen regardless of other constraints imposed by lower level constraint layers.

The second constraint layer 902(2) contains company-mandated constraints that specify behavior appropriate for the company operating the application. Suppose that the company constraint layer specifies that all user interface screens presented to users be branded with the company's logo. When the resolver 904 resolves the two highest constraint layers-legal and company-the application will only serve logon pages that display the legal notice and the corporate brand.

The third constraint layer 902(3) contains customer-desired constraints that provide behavior preferred by customers of the operating company. Perhaps one customer prefers that the web pages adhere to a company color scheme of red, gold, and white. The fourth constraint layer 902(4) contains cultural constraints that stipulate behavior mandated by the culture to which the application's user belongs. For example, one local culture might stipulate that a certain color, such as red, cannot be used in web pages because it is culturally or politically unacceptable.

The fifth constraint layer (illustrated as layer 902(K), where K=5) contains personal user constraints that specify personal preferences. Continuing our example, suppose the user prefers that any objects and images appearing on web pages conform to a certain theme, such as a period theme (1950s or 1960s) or a topic theme (e.g., sports, travel, etc.).

The constraint resolver 904 resolves the five constraint layers, reconciling any conflicting constraints. For instance, constraints imposed by the fifth constraint layer to accommodate user preferences are subject to constraints imposed by any of the four higher constraint layers. If a higher constraint layer imposes constraints that prevent a behavior preferred by the user (e.g., the cultural constraint layer objects to the color red, even though this color is preferred by the user), the user preference is not accommodated by the application.

Once all the constraints are resolved, pages that are generated by the application are constrained by the sum of the constraints. For example, a user in one culture may receive a logon page with the legal notice (legal constraint layer) and company logo (corporate constraint layer), depicted in gold and white colors (customer constraint layer), without the red color (cultural constraint layer), with objects and images conforming to a baseball theme (user constraint layer). All constraint layers constrained the behavior of the application when producing the resulting page that is served to the client.

One advantage of employing the constraint hierarchy is that multiple instances of the same application can behave entirely differently based on the constraint layers in place and the user's situation during interaction with the application. For instance, another user located in a different culture may receive a logon page with the legal notice (legal constraint layer) and company logo (corporate constraint layer), depicted in red, gold and white colors (customer constraint layer without being further constrained by the cultural constraint layer) and with objects and images conforming to a 1960s theme (user constraint layer). The login page would look very different, but would permit user interaction with the same underlying server application.

Accordingly, the constraint hierarchy enables many requirements and constraints from different parties and entities to be combined and affect a live application. As conditions, attitudes, preferences, and culture change, the constraint hierarchy can be modified to accommodate such changes.

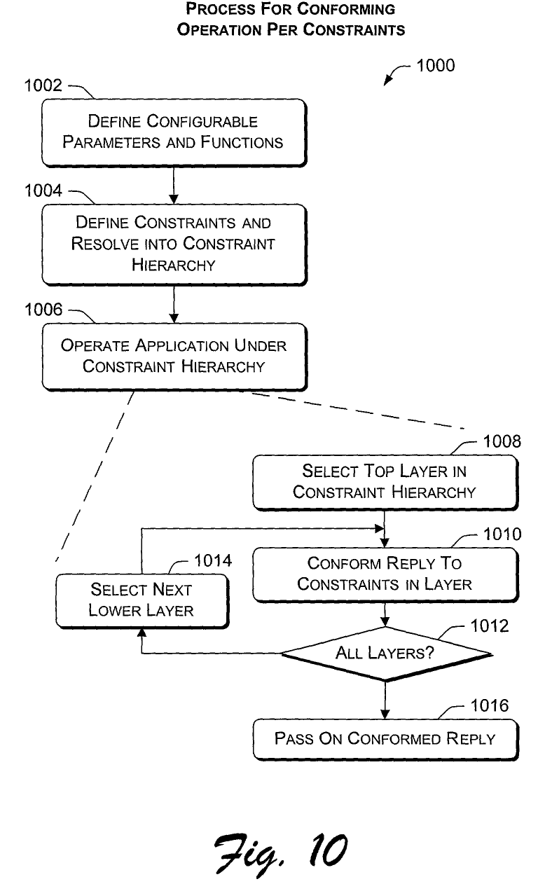

FIG. 10 shows a process 1000 for constraining operation of the application according to preferences of different groups. The process 1000 may be implemented in software as computer-readable instructions, that when executed at the server system 106, perform the acts depicted in the blocks.

At block 1002, the configurable parameters and functions of the application are defined and collected in memory. At block 1004, various constraints imposed by one or more parties to constrain the parameters and functions are resolved into a hierarchy. One exemplary hierarchy is illustrated in FIG. 9. At block 1006, the application operates under the constraint hierarchy to observe the constraints imposed by the various layers.

One exemplary operation pertaining to generating an appropriate reply according to the constraint hierarchy is illustrated as blocks 1008-1018. For discussion purposes, suppose that a reply is recently generated by the business logic and is ready to be presented back to the user. Prior to be served, however, the reply is passed through the constraint hierarchy 900 to modify the reply according to the constraints.

At block 1008, the first layer in the hierarchy is selected for analysis. The first layer imposes certain constraints (e.g., legal constraints) to which the reply is conformed (i.e., block 1010). As one example, this conformance is achieved by attaching one or more tags or other metadata to the reply to instruct the presentation layer 212 that these certain constraints are to be observed when preparing the reply for return to the client.

The reply is evaluated against each layer in the constraint hierarchy, as represented by blocks 1012 and 1014. Once the reply is conformed to all constraint layers (i.e., the “yes” branch from block 1012), the reply is passed on to the next module in the architecture, such as the presentation layer 212 (i.e., block 1016).

### CONCLUSION

The discussions herein are directed primarily to software modules and components. Alternatively, the systems and processes described herein can be implemented in other manners, such as firmware or hardware, or combinations of software, firmware, and hardware. By way of example, one or more Application Specific Integrated Circuits (ASICs) or Programmable Logic Devices (PLDs) could be configured to implement selected components or modules discussed herein.

Although the invention has been described in language specific to structural features and/or methodological acts, it is to be understood that the invention defined in the appended claims is not necessarily limited to the specific features or acts described. Rather, the specific features and acts are disclosed as exemplary forms of implementing the claimed invention.

What is claimed is:

1. A server system, comprising:
one or more computers;
an application executing on the computers to receive and process client requests; and
a constraint system to constrain operation of the application according to multiple different constraints, the constraint system comprising a hierarchy of constraint layers, with each constraint layer containing a set of one or more constraints that customize operation of the application.

2. A server system as recited in claim 1, wherein the hierarchy comprises a constraint layer that contains legally mandated constraints to constrain operation of the application according to legal principles.

3. A server system as recited in claim 1, wherein the hierarchy comprises a constraint layer that contains company-mandated constraints to constrain operation of the application according to preferences of a company that operates the application.

4. A server system as recited in claim 1, wherein the hierarchy comprises a constraint layer that contains customer constraints to constrain operation of the application according to preferences of customers.

5. A server system as recited in claim 1, wherein the hierarchy comprises a constraint layer that contains cultural constraints to constrain operation of the application according to cultural aspects.

6. A server system as recited in claim 1, wherein the hierarchy comprises a constraint layer that contains end user constraints to constrain operation of the application according to preferences of an end user.

7. A server system as recited in claim 1, wherein the constraint layers are organized within the hierarchy such that a first constraint layer limits a second constraint layer but the second constraint layer does not limit the first constraint layer.

8. A server system as recited in claim 1, further comprising a constraint resolver to resolve the constraint layers so that operation of the application is constrained by a sum of the constraints in the layers.

9. A server system comprising:
one or more computers; and
a multi-layer application executing on the computers to handle client requests, the multi-layer application comprising:
a problem-solving logic layer to process the client requests according to an associated problem domain, the problem-solving logic layer containing one or more execution models to perform various sets of tasks when processing the client requests, the problem-solving logic layer producing replies to the client requests;
a presentation layer to structure the replies produced by the problem-solving logic layer in a manner that makes them presentable on various client devices; and
a constraint hierarchy of multiple constraint layers, each constraint layer containing a set of one or more constraints that specify how the replies should be structured to customize the replies for specific sets of conditions.

10. A server system as recited in claim 9, wherein constraint layers can be selectively added or removed from the constraint hierarchy independently of other layers in the multi-layer application to produce different sets of constraints.

11. A server system as recited in claim 9, wherein the constraint hierarchy comprises a constraint layer that contains legally mandated constraints that constrain the presentation layer to structure the replies to comply with certain legal principles.

12. A server system as recited in claim 9, wherein the constraint hierarchy comprises a constraint layer that contains company-mandated constraints that constrain the presentation layer to structure the replies according to preferences of a company that operates the application.

13. A server system as recited in claim 9, wherein the constraint hierarchy comprises a constraint layer that contains customer-oriented constraints that constrain the presentation layer to structure the replies according to preferences of customer s.

14. A server system as recited in claim 9, wherein the constraint hierarchy comprises a constraint layer that contains cultural constraints that constrain the presentation layer to structure the replies according to cultural aspects.

15. A server system as recited in claim 9, wherein the constraint hierarchy comprises a constraint layer that contains end user constraints that constrain the presentation layer to structure the replies according to preferences of end users.

16. A server system as recited in claim 9, wherein the constraint layers can be removed or added to modify the set of constraints imposed on structuring the replies.

17. A computer software architecture embodied on one or more computer-readable media, comprising:
a constraint hierarchy of multiple constraint layers, each constraint layer containing a set of one or more constraints that constrain operation of an application, the constraint layers being organized within the constraint hierarchy such that a first constraint layer limits a second constraint layer but the second constraint layer does not limit the first constraint layer; and
a constraint resolver to resolve the constraint layers so that operation of the application is constrained by a set of the constraints in the constraint layers.

18. A computer software architecture as recited in claim 17, wherein constraint layers are selectively added to or removed from the constraint hierarchy to form different sets of constraints on the operation of the application.

19. A computer software architecture as recited in claim 17, wherein the constraint hierarchy comprises a constraint layer that contains legally mandated constraints to constrain operation of the application according to legal principles.

20. A computer software architecture as recited in claim 17, wherein the constraint hierarchy comprises a constraint layer that contains company-mandated constraints to constrain operation of the application according to preferences of a company that operates the application.

21. A computer software architecture as recited in claim 17, wherein the constraint hierarchy comprises a constraint layer that contains customer constraints to constrain operation of the application according to preferences of customers.

22. A computer software architecture as recited in claim 17, wherein the constraint hierarchy comprises a constraint layer that contains cultural constraints to constrain operation of the application according to cultural aspects.

23. A computer software architecture as recited in claim 17, wherein the constraint hierarchy comprises a constraint layer that contains end user constraints to constrain operation of the application according to preferences of an end user.

24. A method comprising:
storing a hierarchy of constraints, each constraint being configured to constrain operation of a server application; and
evaluating an operation of the server application in view of the hierarchy of constraints to modify operation according to the constraints in the hierarchy.

25. A method as recited in claim 24, further comprising adding or removing constraints from the hierarchy to alter operation of the server application.

26. A method as recited in claim 24, wherein the hierarchy of constraints comprises constraints selected from a group of constraints comprising:
legally mandated constraints to constrain operation of the application according to legal principles;
company-mandated constraints to constrain operation of the application according to preferences of a company that operates the application;
customer constraints to constrain operation of the application according to preferences of customers;
cultural constraints to constrain operation of the application according to cultural aspects; and
end user constraints to constrain operation of the application according to preferences of an end user.

27. A method for operating a server application, comprising:
receiving requests from multiple clients;
processing the requests to produce replies;
structuring the reply to define how the reply will appear when presented at the client; and
constraining said structuring according to a set of one or more constraints to customize appearance of the reply, the constraints comprising:
legally mandated constraints to constrain appearance of the reply according to legal principles;
company-mandated constraints to constrain appearance of the reply according to preferences of a company that operates the application;
customer constraints to constrain appearance of the reply according to preferences of customers;
cultural constraints to constrain appearance of the reply according to cultural aspects; and
end user constraints to constrain appearance of the reply according to preferences of an end user.

28. A method as recited in claim 27, further comprising adding or removing constraints to change the set of constraints being applied to the structuring of the reply.

29. One or more computer-readable media comprising computer-executable instructions that, when executed, direct an application server to:
generate replies in response to client requests; and
structure the replies according to a hierarchy of constraints to customize the replies, the constraints comprising a combination of one or more following constraints:
legally mandated constraints to constrain appearance of a reply according to legal principles;
company-mandated constraints to constrain appearance of the reply according to preferences of a company that operates the application;
customer constraints to constrain appearance of the reply according to preferences of customers;
cultural constraints to constrain appearance of the reply according to cultural aspects; and
end user constraints to constrain appearance of the reply according to preferences of an end user.
